(19) United States
(12) Patent Application Publication
(10) Pub. No.: US 2019/0120628 A1
(43) Pub. Date: Apr. 25, 2019

(54) METHOD AND SYSTEM FOR AUTOMATICALLY ADJUSTING AIRDROP PARAMETERS FOR A DYNAMIC DROP ZONE

(71) Applicant: HONEYWELL INTERNATIONAL INC., Morris Plains, NJ (US)

(72) Inventors: Gerald Parras, Albuquerque, NM (US); Sivakumar Kanagarajan, Madurai (IN); Sreenivasan Govindillam K, Bengaluru (IN)

(73) Assignee: HONEYWELL INTERNATIONAL INC., Morris Plains, NJ (US)

(21) Appl. No.: 15/790,248

(22) Filed: Oct. 23, 2017

(51) Int. Cl. G01C 21/20; G08G 5/00

(52) U.S. Cl. CPC G01C 21/20; G08G 5/0021; G08G 5/0091; G08G 5/0034; G08G 5/0039; G08G 5/006

(57) ABSTRACT

Methods and systems are provided for automatically adjusting aircraft performance parameters for use on an airdrop. The method comprises establishing and transmitting initial dimensions for a drop zone from a ground element to a flight management system (FMS) of an in-flight cargo aircraft via a secure data link. The ground element continually monitors ground-based parameters affecting the dimensions of the drop zone and transmits changes to the parameters to the FMS via the secure data link. The FMS adjusts a computed air release point (CARP) for the airdrop and continually updates flight performance parameters for the in-flight cargo aircraft based on the changes to the ground-based parameters.

### TECHNICAL FIELD

The present invention generally relates to aircraft operations, and more particularly relates to a method and system for automatically adjusting airdrop parameters for a dynamic drop zone.

### BACKGROUND

Reinforcement and resupply of ground elements in remote locations is often accomplished by an airdrop. This may include a battlefield with pockets of friendly forces. This may also include other types of operations including humanitarian aid, disaster relief, and firefighting. In every airdrop, accuracy and precision are important. However, changing and dynamic ground conditions may affect the target drop zone. Hence, there is a need for a method and system for automatically adjusting airdrop parameters for a dynamic drop zone.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

A method is provided for automatically adjusting aircraft performance parameters for use on an airdrop. The method comprises: establishing initial dimensions for a drop zone by a ground element; transmitting the initial dimensions for the drop zone from the ground element to a flight management system (FMS) of an in-flight cargo aircraft via a secure data link; continually monitoring ground-based parameters affecting the dimensions of the drop zone with the ground element; transmitting changes to the ground-based parameters from the ground element to the FMS via the secure data link; continually adjusting a computed air release point (CARP) for the airdrop with the FMS based on the changes to the ground-based parameters; and continually updating flight performance parameters for the in-flight cargo aircraft with the FMS based on the changes to the ground-based parameters.

A system is provided for automatically adjusting aircraft performance parameters for use on an airdrop. The system comprises: an in-flight cargo aircraft designated to conduct an airdrop; a ground element that establishes and transmits initial dimensions for drop zone to the in-flight cargo aircraft, where the ground element continually monitors ground-based parameters affecting the dimensions of the drop zone and transmits changes to the ground-based parameters to the aircraft via a secure communications data link; and a flight management system (FMS) on board the in-flight aircraft that receives the changes to the ground-based parameters from the ground element and adjusts a computed air release point (CARP) for the air drop based on the changes to the ground-based parameters.

Furthermore, other desirable features and characteristics of the method and system will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIG. 1 shows a diagram of a usable drop zone in accordance with one embodiment; and

FIG.2 shows a flowchart of a method for automatically adjusting aircraft performance parameters for use on an airdrop in accordance with one embodiment.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

A method and system for automatically adjusting aircraft performance parameters for use on an airdrop has been developed. The initial dimensions of a drop zone are established by a ground element and transmitted to an in-flight cargo aircraft. The ground element continually monitors ground-based parameters that might affect the dimensions of the drop zone. Any changes to these parameters are transmitted to the flight management system (FMS) on board the aircraft. The FMS will adjust the computed air release point (CARP) for the airdrop and update flight performance parameters for the aircraft based on the changes to the ground-based parameters.

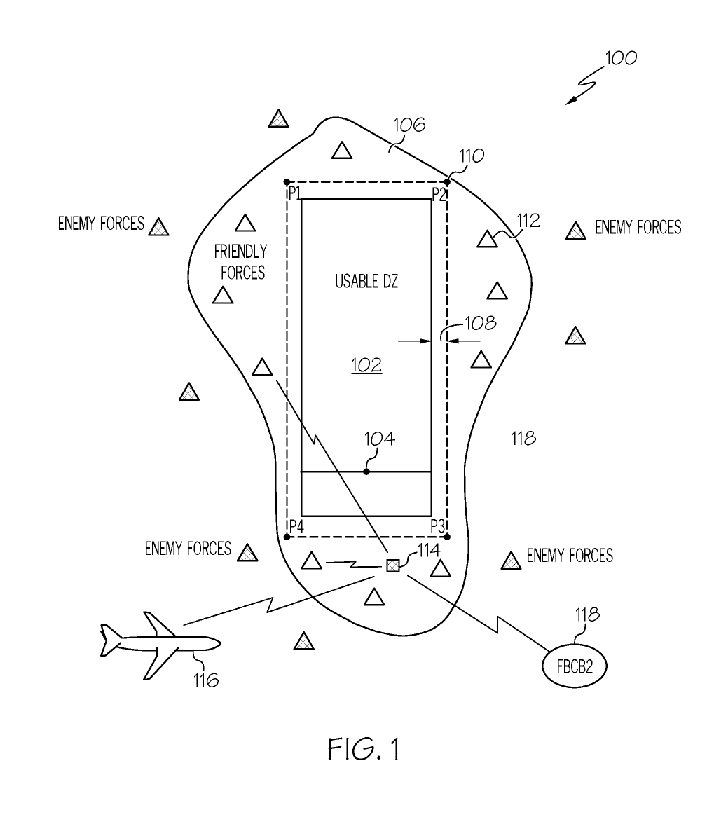

Turning now to FIG. 1, a diagram 100 of a usable drop zone 102 is shown in accordance with one embodiment. The initial dimensions of the usable drop zone 102 are first established by a ground-based element 114. The drop zone 102 is typically rectangular shaped to include a buffer distance 108 that allows for any estimated inaccuracies of airdrop performance. The ground-based element 114 may establish the dimensions of the drop zone 102 by generating four separate position points 110 to designate each corner of the rectangular shaped drop zone 102. In the alternative, the ground element may designate a desired point of impact 104 and a corresponding length and width of the rectangular shaped drop zone 102 with the desired point of impact 104 acting as a designated anchor point.

The ground element 114 will transmit the initial dimensions for the drop zone 102 to an in-flight cargo aircraft 116. The dimensions may be communicated via a secure data link that may include utilizing the Force XXI Battle Command Brigade and Below (FBCB2) communication protocol in some embodiments. After the initial dimensions are transmitted, the ground element 114 will continue to monitor ground-based parameters that may affect the dimensions of the drop zone. In this embodiment, the ground-based parameters may include the disposition of enemy forces outside a friendly area of control 106. If the ground-based parameters change, these changes are transmitted by the ground-based element 114 to the aircraft 116.

On board the aircraft 116, a flight management system (FMS) receives both the initial dimensions of the drop zone and any changes to the ground-based parameters from the ground element. The FMS continually updates a computed air release point (CARP) for the airdrop based on these changes the ground-based parameters. The CARP is a calculated point where the aircraft will begin air dropping its payload to hit the desired point of impact 104. Additionally, the FMS also updates the flight performance parameters for the aircraft itself such as altitude, airspeed, track, etc.

In some embodiments, the ground-based parameters monitored by the ground element may include: real-time weather data; real-time atmospheric data; the location of friendly forces; and the location of enemy forces. The CARP and flight parameters of the aircraft may be adjusted by the FMS for updated usable dimensions of the drop zone based on these ground-based parameters. Additionally, the CARP and flight parameters of the aircraft may be adjusted to complete the airdrop in a single pass of the aircraft or multiple passes of the aircraft. Also, the CARP and flight parameters of the aircraft may be adjusted to abort the airdrop when the usable dimensions of the drop zone become inadequate to ensure a successful airdrop within the estimated accuracy of the system (i.e., inside the perimeter of the buffer zone). Other flight parameters that may be utilized by the FMS include: the number and type of personnel to be dropped; the equipment type (canister, heavy equipment, etc.); and the types of parachutes used in the airdrop.

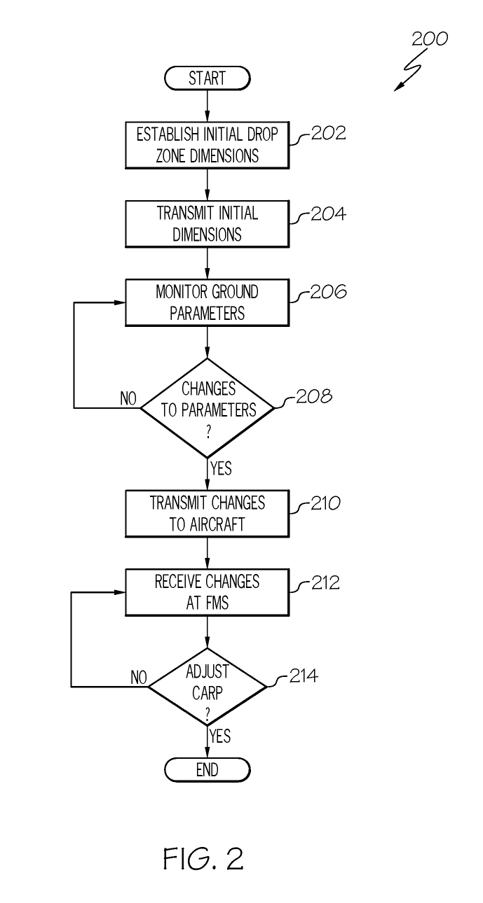

Turning now to FIG. 2, a flowchart 200 is shown of a method for automatically adjusting aircraft performance parameters for use on an airdrop in accordance with one embodiment. First, initial drop zone dimensions are established by a ground element 202 and transmitted to an FMS on board an in-flight cargo aircraft 204. The ground element continues to monitor ground parameters that may affect the drop zone dimensions 206. If there are changes to the parameters 208, the changes are transmitted to the in-flight aircraft 210 and received by its onboard FMS 212. The FMS receives the changes to the ground parameters and determines any necessary adjustments to the CARP and the flight parameters of the aircraft 214. The method continually monitors the changes to the ground parameters and continually updates the CARP and flight parameters of the aircraft as necessary.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method for automatically adjusting aircraft performance parameters for use on an airdrop, comprising:
establishing initial dimensions for a drop zone by a ground element;
transmitting the initial dimensions for the drop zone from the ground element to a flight management system (FMS) of an in-flight cargo aircraft via a secure data link;
continually monitoring ground-based parameters affecting the dimensions of the drop zone with the ground element;
transmitting changes to the ground-based parameters from the ground element to the FMS via the secure data link;
continually adjusting a computed air release point (CARP) for the airdrop with the FMS based on the changes to the ground-based parameters; and
continually updating flight performance parameters for the in-flight cargo aircraft with the FMS based on the changes to the ground-based parameters.

2. The method of claim 1, where the initial dimensions for the drop zone are rectangular shaped.

3. The method of claim 2, where the rectangular shaped drop zone is established by defining a position point for each corner.

4. The method of claim 2, where the rectangular shaped drop zone is established by designating an anchor point with a designated length of the drop zone and width of the drop zone referenced from the anchor point.

5. The method of claim 1, where the secure data link is a Force XXI Battle Command Brigade and Below (FBCB2) tactical datalink.

6. The method of claim 1, where the ground-based parameters comprise real-time weather data.

7. The method of claim 1, where the ground-based parameters comprise real-time atmospheric data.

8. The method of claim 1, where the ground-based parameters comprise the location of friendly forces.

9. The method of claim 1, where the ground-based parameters comprise the location of enemy forces.

10. The method of claim 1, where the CARP is adjusted for updated usable dimensions for the drop zone.

11. The method of claim 1, where the CARP is adjusted to complete the airdrop in a single pass of the aircraft.

12. The method of claim 1, where the CARP is adjusted to complete the airdrop in multiple passes of the aircraft.

13. The method of claim 1, where the CARP is adjusted to abort the airdrop.

14. The method of claim 1, where the CARP is adjusted based on the number of personnel in the airdrop.

15. The method of claim 1, where the CARP is adjusted based on the type of equipment in the airdrop.

16. The method of claim 1, where the CARP is adjusted based on the type of parachute utilized in the airdrop.

17. A system for automatically adjusting aircraft performance parameters for use on an airdrop, comprising:
an in-flight cargo aircraft designated to conduct an airdrop;
a ground element that establishes and transmits initial dimensions for drop zone to the in-flight cargo aircraft, where the ground element continually monitors ground-based parameters affecting the dimensions of the drop zone and transmits changes to the ground-based parameters to the aircraft via a secure communications data link; and
a flight management system (FMS) on board the in-flight aircraft that receives the changes to the ground-based parameters from the ground element and adjusts a computed air release point (CARP) for the air drop based on the changes to the ground-based parameters.

18. The system of claim 17, where the CARP is adjusted by the FMS for updated usable dimensions for the drop zone.
